(19) United States
(12) Patent Application Publication
(10) Pub. No.: US 2024/0251176 A1
(43) Pub. Date: Jul. 25, 2024

(54) PERSPECTIVE-CORRECT PASSTHROUGH ARCHITECTURES FOR HEAD-MOUNTED DISPLAYS

(71) Applicant: Meta Platforms Technologies, LLC, Menlo Park, CA (US)

(72) Inventors: Nathan MATSUDA, Seattle, WA (US); Grace Elizabeth KUO, Seattle, WA (US); Douglas Robert LANMAN, Bellevue, WA (US); Eric PENNER, Redmond, WA (US); Clinton SMITH, Kirkland, WA (US); Seth MOCZYDLOWSKI, Austin, TX (US); Alexander CHING, Kenmore, WA (US)

(73) Assignee: Meta Platforms Technologies, LLC, Menlo Park, CA (US)

(21) Appl. No.: 18/420,349

(22) Filed: Jan. 23, 2024

Related U.S. Application Data
(60) Provisional application No. 63/441,136, filed on Jan. 25, 2023.

(51) Int. Cl. H04N 23/957; G02B 27/01; G06V 10/10; G06V 40/18

(52) U.S. Cl. CPC H04N 23/957; G02B 27/0172; G06V 10/16; G06V 40/193

(57) ABSTRACT

According to examples, an image capture device may include a lens array including lenses supported by a lens support structure, in which the lenses are arranged to capture light rays from multiple view-points. The image capture device may also include a sensor to capture light and convert the captured light into data that is used to form an image and a plurality of apertures positioned between the lenses and the sensor, in which the apertures are positioned with respect to the lenses and the sensor to allow rays of light that would have reached a certain reference location spaced from the sensor to pass through the plurality of apertures. An optimization algorithm may be applied to the collected sensor data to reproduce an image of a scene at a perspective that is intended to match a virtual eye position that is offset from the location of the sensor.

### TECHNICAL FIELD

This patent application relates generally to head-mounted displays (HMDs). Particularly, this patent application relates to HMDs having light field passthrough architectures that capture images from the perspective of a virtual eye behind a camera mounted to the fronts of the HMDs.

### BACKGROUND

With recent advances in technology, prevalence and proliferation of content creation and delivery have increased greatly in recent years. In particular, interactive content such as virtual reality (VR) content, augmented reality (AR) content, mixed reality (MR) content, and content within and associated with a real and/or virtual environment (e.g., a “metaverse”) has become appealing to consumers.

Wearable devices, such as a wearable eyewear, wearable headsets, head-mountable devices, and smartglasses, have gained in popularity as forms of wearable systems. In some examples, such as when the wearable devices are eyeglasses or smartglasses, the wearable devices may include transparent or tinted lenses. In some examples, the wearable devices may employ imaging components to capture image content, such as photographs and videos. In some examples, such as when the wearable devices are head-mountable devices or smartglasses, the wearable devices may employ a first projector and a second projector to direct light associated with a first image and a second image, respectively, through one or more intermediary optical components at each respective lens, to generate “binocular” vision for viewing by a user.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a perspective view of a HMD that includes a pair of image capture devices, according to an example.

FIG. 2A illustrates a front perspective view of the image capture device depicted in FIG. 1, according to an example.

FIG. 2B illustrates a cross-sectional side view of the image capture device depicted in FIGS. 1 and 2A, according to an example.

FIG. 3 illustrates a diagram of an image capture device, according to an example.

FIG. 4 illustrates a graph of an epipolar space corresponding to the rays represented in FIG. 3, according to an example.

FIG. 5A illustrates a graph depicting a relationship between a distance from a camera sensor to an eye and a focal length, according to an example.

FIG. 5B illustrates a graph depicting a relationship between a distance from a camera sensor to an eye and a lens array size, according to an example.

FIG. 6A illustrates a representation of raw sensor data captured through the image capture device of a scene illustrated in FIG. 6B, according to an example.

FIG. 6B illustrates a scene, according to an example.

FIG. 7A illustrates a diagram that depicts lenses focused at a point p₁ (dashed line) and a closer point p₂ (solid line) that focuses behind the sensor, creating a defocus blur in the raw data, as shown in the graph in FIG. 7B, according to an example.

FIG. 7B illustrates a graph of raw data as a function of intensity at different planes as shown in FIG. 7A, according to an example.

FIGS. 7C and 7D, respectively, illustrate graphs of reconstructions for calibrations at different planes as shown in FIG. 7A as a function of intensity, according to examples.

FIG. 8 illustrates a block diagram of a HMD that includes an image capture device that is to enable the display of a scene at a perspective that matches a virtual eye position that is offset from the location of a sensor in the image capture device, according to an example.

FIG. 9 illustrates a perspective view of a HMD, according to an example.

FIG. 10 illustrates a flow diagram of a method for reproducing an image at a perspective that matches a virtual eye position, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

Virtual reality (VR) head-mounted displays (HMDs) (or equivalently, head-mountable displays) offer immersive experiences thanks to their high contrast imagery and large field-of-view (FoV), but users are isolated in the virtual world since the headset blocks the user from seeing their surroundings. In contrast, augmented reality (AR) uses transparent displays, allowing users to be fully present in their environment, but today's AR displays have limited FoV. Furthermore, virtual content in AR must compete with environmental lighting, which reduces display contrast. Representing occlusions between virtual objects and real objects is particularly challenging as it often requires removing light from the scene. To date, hard-edged occlusions in AR have not been demonstrated with a practical form factor.

VR passthrough offers a compromise through use of external facing cameras on the front of the HMD to allow the user to see their environment. By streaming video from external facing cameras into a VR headset, passthrough allows users to view their surroundings without sacrificing the advantages of VR hardware. For users to seamlessly interact with their environment, the displayed passthrough image should match what the user would see without the headset. However, since passthrough cameras cannot physically be co-located with the user's eye, the passthrough image has a different perspective than what the user would see without the headset. Even if passthrough cameras are placed directly in front of the eyes, there is still an axial offset due to the thickness of the HMD. Streaming these images directly to the user causes visual displacement. Additionally, although the image may computationally be reprojected into the desired view, errors in depth estimation, view-dependent effects, and missing information at occlusion boundaries can lead to undesirable artifacts.

Visual displacement can be corrected computationally by estimating depth of objects in the scene and reprojecting the camera views to the eye location. However, errors in the depth estimation and missing information at occlusion boundaries may create artifacts in the passthrough image. Furthermore, any view synthesis algorithm must run with low latency, potentially on mobile hardware.

Visual displacement between passthrough cameras and the user's eye can cause negative perceptual effects and make it more challenging for users to interact with the real world. In a conventional approach, a video passthrough system was built with axial and vertical displacement of the cameras (165 mm and 62 mm, respectively) and it was found that users were slower by 43% at manual tasks and had significant pointing errors compared to a transparent headset. Although pointing errors reduced as the users adapted to the visual displacement, the pointing errors never returned to baseline, and participants experienced negative after-effects in the form of increased errors after the headset was removed. Another approach compared hand-eye coordination in headsets over a range of visual displacements, including using a mirror to place the cameras at the user's eye. The users performed tracing tasks faster with the mirror configuration, compared to when the cameras where located in front of the headset, even with no vertical displacement. However, participants were faster and more accurate without the headset at all, suggesting visual displacement is not the only characteristic of VR passthrough affecting task performance. In another approach, adaptation to visual displacement was tested over several configurations and found participants adapted within 10 minutes. However, participants also reported a feeling of “body structure distortion” in which they had the sensation that their limbs were attached to their bodies in the wrong locations. Studies of large lateral displacements (50 mm-300 mm) found that task performance decreased with larger visual displacement and simulator sickness increased. In contrast to the other studies, another approach found users could estimate the size and position of objects equally well when the cameras were at the eye versus when they were displaced up to 40 mm axially. Although this suggests that modest displacements may be acceptable, the resolution of the study's headset was only 640×480, and modern displays have over an order of magnitude more pixels. It is likely users will be more sensitive to visual displacement errors with higher resolution HMDs.

One option to remove visual displacement is to computationally synthesize the view at the eye location from a small number of cameras on the front of the headset. View synthesis is a widely-researched problem; popular solutions include classical image-based rendering, multiplane images, and neural radiance fields. However, these techniques are not tailored to VR passthrough, which requires low latency and temporally consistent view synthesis. To address this gap, a practical real-time passthrough algorithm has been proposed, in which depth is estimated from a stereo pair of cameras enabling reprojection to match the desired perspective. The algorithm enables real-time passthrough on a mobile device but can have significant warping artifacts from inaccuracies in the depth estimation, particularly around near objects and occlusion boundaries. More recently, a neural passthrough approach using modern machine learning techniques to improve depth estimation and fill in missing information at occlusions has been proposed. However, specularities and repeating patterns in the scene can cause artifacts, and the algorithm is too computationally intensive for mobile headsets.

Another option for removing visual displacement is to design an optical architecture that directly captures the rays that would have gone into the eye, therefore capturing the correct perspective. In these architectures, the camera view doesn't require post processing beyond distortion correction and can be streamed directly to the user with low latency. One approach is to use a mirror at a 45° angle in front of the headset, which folds the optical path to a camera placed above or below the device. However, the form factor cost is high as the mirror sticks out, approximately doubling the headset track length. Another approach involved replacing the mirror with a prism, which uses total internal reflection (TIR) to fold the light path, reducing camera form factor. However, the solid mass of the prism adds substantial weight, and the FoV will be limited to angles that match the TIR condition.

A dense light field may contain all the information necessary to synthesize novel views, making light fields a temping candidate for passthrough. However, dense light fields are traditionally captured by scanning the camera location, which may be unsuitable for real-time applications, or using large camera arrays, which is unrealistic for HMDs. Although compact, single-exposure versions have been described using lens arrays, angular sensitive pixels, Frensel zone plates, and metasurfaces. Light fields have a trade-off between spatial and angular resolution, and as a result, these devices either have low spatial resolution or insufficient angular sampling for artifact-free view synthesis.

Disclosed herein are image capture devices that may directly sample the rays that would have gone into a HMD user's eye, several centimeters behind a sensor of the image capture devices. The image capture devices disclosed herein contain an array of lenses with an aperture behind each lens. The apertures are strategically placed to allow certain rays of light to pass through the apertures. Particularly, the apertures are strategically placed to allow rays of light that would have reached a certain reference location spaced from a sensor to pass through the apertures. The certain reference location may be a virtual eye position as discussed herein.

Also disclosed herein are image capture devices that may use an alternate approach in which the optical hardware and a corresponding image reconstruction algorithm may be implemented, for instance, for light field passthrough. Particularly, for instance, disclosed herein are image capture devices, e.g., cameras, that may directly measure the exact rays that would have gone into the user's eye, located behind the camera sensor. Unlike prior architectures that optically capture the correct view with mirrors or prisms, the image capture devices disclosed herein are thin and flat, allowing the image capture devices to meet form factor requirements of a VR HMD.

Through implementation of the features of the present disclosure, an image capture device for VR passthrough based on the light field passthrough architecture disclosed herein may be provided. An image capture device of the present disclosure may accurately capture images from the perspective of a virtual eye behind the image capture device camera in a compact form factor suitable for HMDs. The present disclosure also includes an analysis of a light field passthrough design space and further provides a practical calibration technique and computationally lightweight algorithm for image reconstruction, including coarse depth estimation and gradient domain image stitching. The image may be captured and reconstructed in a relative short period of time, for instance, in a combined runtime under 1.7 ms per frame. In some examples, the features of the present disclosure may enable a fully-functional binocular passthrough HMD that captures a correct perspective of a user of the HMD, even for challenging scenes with near-field content, specular reflections, and transparent objects.

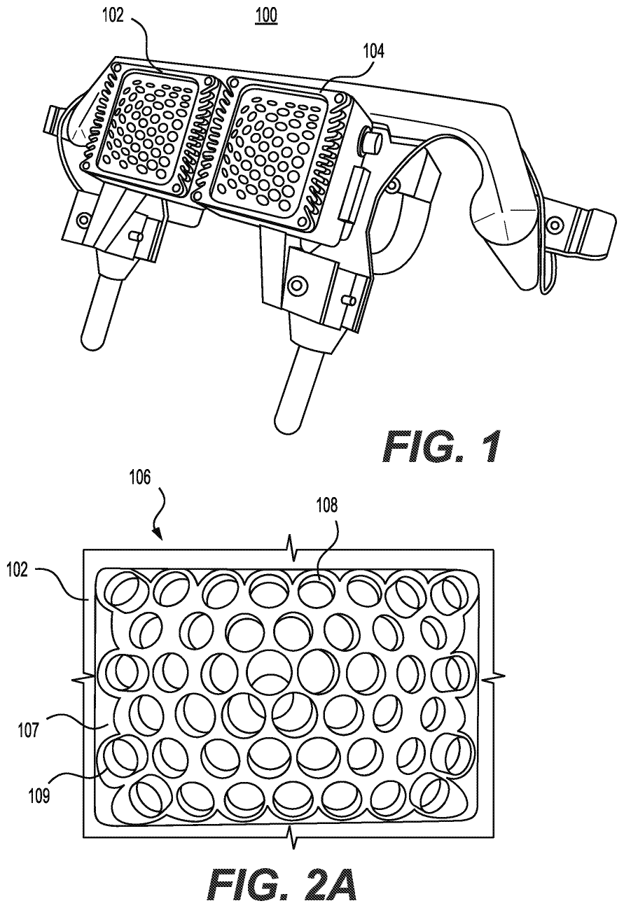

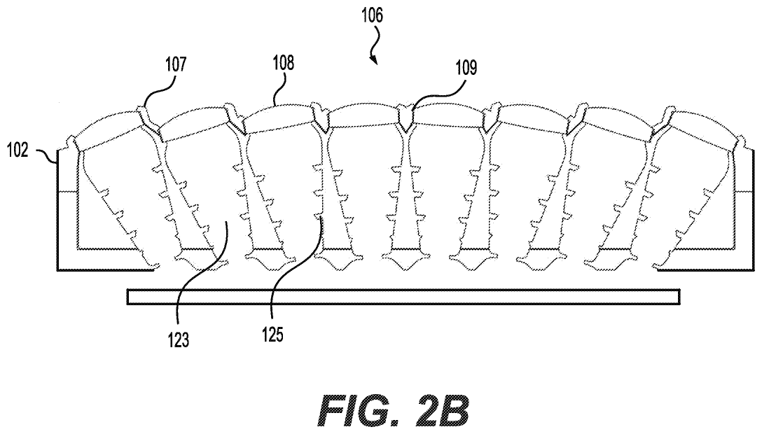

Reference is made to FIGS. 1, 2A, and 2B. FIG. 1 illustrates a perspective view of a HMD 100 that includes a pair of image capture devices 102, 104, according to an example. FIG. 2A illustrates a front perspective view of the image capture device 102 depicted in FIG. 1, according to an example. FIG. 2B illustrates a cross-sectional side view of the image capture device 102 depicted in FIGS. 1 and 2A. The HMD may be a “near-eye display”, which may refer to a device (e.g., an optical device) that may be in close proximity to a user's eye. As used herein, “artificial reality” may refer to aspects of, among other things, a “metaverse” or an environment of real and virtual elements, and may include use of technologies associated with virtual reality (VR), augmented reality (AR), and/or mixed reality (MR). As used herein a “user” may refer to a user or wearer of a “near-eye display.”

The image capture device 102, which may also be referenced herein as a camera 102, may include a lens array 106. The image capture device 104 may include the same components as the image capture device 102. In this regard, the following discussion of the components of the image capture device 102 may also correspond to the components of the image capture device 104.

The lens array 106 may include a plurality of lenses 108 supported by a lens support structure 107. The lens support structure 107 may support the lenses 108 in a manner such that the lenses 108 may capture light rays from multiple view-points. As shown in FIGS. 1, 2A, and 2B, the lens support structure 107 may include a plurality of openings 109 arranged at multiple angles with respect to each other. A respective lens 108 may be provided in each of the openings 109 and each of the lenses 108 may be positioned at certain angles with respect to horizontal and vertical axes of the image capture device 102.

According to examples, the lens support structure 107 may be formed of any suitable material to support the lenses 108 as disclosed herein. For instance, the lens support structure 107 may be formed of a plastic material, a rubber material, a silicone material, a metallic material, and/or the like. In addition, the lens support structure 107 may be opaque to physically block rays of light that do not pass through the lenses 108. In some examples, and as shown in FIG. 2B, the lens support structure 107 may extend into the image capture device 102 such that respective lens tubes 123 that may extend from the lenses 108 to an interior of the image capture device 102. According to examples, the interiors of the lens tubes 123 may include features to prevent stray light from bouncing off the interior of the lens tubes 123 and making it through the aperture and onto the sensor. As shown in FIG. 2B, the interior of the lens tubes 123 may include baffles 125 that may prevent the bounding of the stray light of the interior of the lens tubes 123. Particularly, a light ray that enters a lens tube 123 at a steeper angle than the ones intended to be captured may hit these baffles 125 and be bounced back out through the lens 108, or be bounced around in the lens tube 123 a number of times to lose sufficient intensity to be below a measurement threshold.

In addition, the lenses 108 may each be formed of any suitable material that may allow most or all of the light impinging on the lenses 108 to pass through the lenses 108. Suitable materials may be include glass, polycarbonate, optical silicone, etc. In some examples, the interiors of the lens tubes 123 may be coated with a low reflectance coating to reduce the intensity of the light rays that hit and bounce off the walls of the lens tubes 123, which may further prevent stray light from reaching the sensor.

Although the image capture device 102 has been depicted as having lenses of a certain type, it should be understood that the image capture device 102 may include any number of lenses without departing from a scope of the present disclosure. In addition, although the image capture device 102 has been depicted as having a certain number of lenses 108, it should be understood that the image capture device 102 may include any number of lenses 108 without departing from a scope of the present disclosure. For instance, one of more of the lenses 108 may be replaced with lenslets. By way of particular example, the lenses 108 may be replaced with a monolithic molded lens array component that includes a plurality of small lenslets. In this example, each lenslet may have its own aperture of a similar size scale molded or chemically etched into a monolithic part. At this smaller scale there could be hundreds or thousands of lenslets, and may be referred to as a Micro Lens Array (MLA). In addition, the lenslets may be fabricated through high volume manufacturing techniques such as molding, etching, laser cutting, etc.

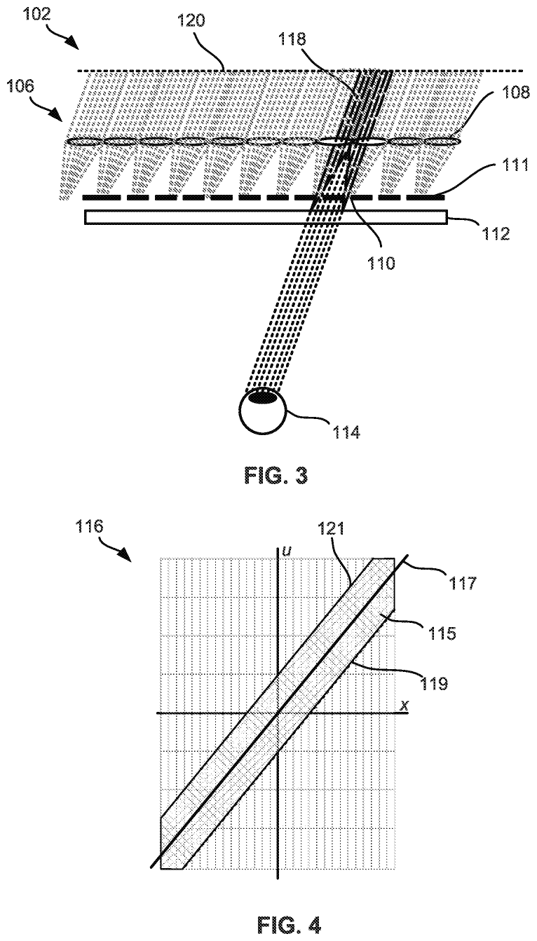

FIG. 3 illustrates a diagram of an image capture device 102, according to an example. As shown, the image capture device 102 may include the lens array 106, a plurality of apertures 110, and a sensor 112. The lens support structure 107 may support the lenses 108 in the lens array 106 as shown in FIG. 2A. The sensor 112 may capture light that has passed through the lenses 108 in the lens array 106 and the apertures 110 and may convert the captured light into data that is used to form an image. The apertures 110 may be positioned between the lenses 108 and the sensor 112 to allow rays of light that would have reached a certain reference location 114 spaced from the sensor 112. In other words, the sections 111 between the apertures 110 may block rays of light that would not have reached the certain reference location 114. The certain reference location 114 (which is also referenced herein as a virtual eye position 114) may be a location at which a user's eye or a virtual eye may be positioned with respect to the image capture device 102 during normal use of the image capture device 102, e.g., when a user is using an HMD having the image capture device 102.

According to examples, the apertures 110 may be positioned behind respective ones of the lenses 108 and at positions such that the sections 111 between the apertures 110 may physically block all of the rays that would not have entered the certain reference location 114, which, as discussed herein, may correspond to a user's eye. In epipolar space, as shown in FIG. 4, the sections 111 between the apertures 110 block all of the rays except for those shown in the gray checkered section 115, leaving only rays around the line 117, which represents a desired view. The sections 111 between the apertures 110 may not just remove samples, they may also change the shape of the measurements in epipolar space, clipping them along the dotted lines 119, 121 in FIG. 4. To understand why, notice in FIG. 3 how the dashed rays 118 from a scene 120 that reach the sensor 112 only cover a fraction of their corresponding lens 108. In comparison, in a traditional light field camera, each measured ray bundle always covers the whole area of the lens, resulting in rectangular samples in epipolar space. The coarse resolution of the light field in the traditional light field camera results in inaccurate sampling of the rays and discontinuities in the synthesized view.

Adding the apertures 110 and sections 111 as disclosed herein may enable measurement of the exact ray bundle that would have gone into the certain reference location 114, e.g., a user's eye. This architecture may be referenced herein as light field passthrough. In addition to capturing the correct view and creating seamless transitions between lenses 108 by blocking most of the light field, the finite number of pixels on the sensor 112 may better be distributed. In contrast, in conventional light field passthroughs, most of the samples aren't used to form the new view. In the present light field passthrough, the samples may be concentrated in the region of interest, resulting in higher spatial resolution in the final image.

The apertures 110 and the sections 111 may be placed with respect to the lenses 108 to only allow rays of light that would have been directed to the certain reference location 114, regardless of the incident angle. This happens when the entrance pupil of each lens 108 is at the certain reference location 114, e.g., user's eye location. By definition, the entrance pupil may be the image of the aperture 110 as seen through the lens 108 from the object side.

According to examples, a virtual aperture at the certain reference location 114 may be defined, which may also be called the virtual eye position 114. For each lens 108 in the array 106, the real aperture 110 and the virtual eye position 114 may be conjugates. Assuming ideal optics, a thin lens equation may be used to determine the locations of the apertures 110 for a given virtual eye position 114. If the virtual eye 114 position is located z_{eye} behind the sensor 112, for a lens with focal length f, the associated aperture is at

$${z}_{ap} = \frac{{f}^{2}}{2 f + {z}_{eye}} \qquad Equation ( 1 )$$

$${u}_{ap} = ( \frac{{z}_{eye} + {z}_{ap}}{{z}_{eye} + f} ) {u}_{lens} \qquad Equation ( 2 )$$

In Equation (2), zₐₚ is the vertical distance from the sensor 112 to the aperture 110 and uₗₑₙₛ, uₐₚ are the lateral distances from the virtual eye position 114 to the center of the lens 108 and aperture 110, respectively. If the virtual eye at the virtual eye position 114 has diameter d_{eye}, then the physical aperture has diameter:

$${d}_{ap} = ( \frac{f - {z}_{ap}}{f + {z}_{eye}} ) {d}_{eye} \qquad Equation ( 3 )$$

Here, it is assumed that the lens is focused at optical infinity (e.g., located f above the sensor 112). Since Equations (1)-(3) assume ideal optics, lens aberrations may change the relationship between the virtual eye position 114 and aperture 110 locations. With ray tracing, the aperture 110 location may be calculated accurately for any imaging lens. To do this, the shape and location of the virtual eye at the virtual eye position 114 may first be defined. Starting with a single point on the boundary of the virtual eye, rays that would intersect that point may be traced. Once the rays pass through the lens 108, they will approximately converge at a new point behind the lens 108. Aberrations will generally cause some spread of the rays, the 3D spot where the rays converge may be estimated, which may be one edge of the aperture 110. By repeating for every point on the boundary of the virtual eye, the boundary of the corresponding aperture 110 may be traced out. In many cases, symmetry may be used to generate the aperture 110 boundary by tracing only a small number of points. However, even though the ray tracing algorithm is more accurate, the ideal lens equations (Equations (1)-(3)) may provide valuable insight into the design space of light field passthrough cameras, which is described further herein below.

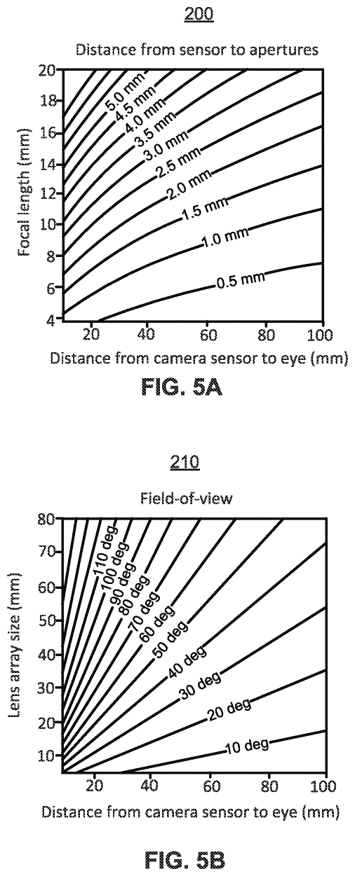

Designs unique to light field passthrough may be considered, which may point towards thinner VR HMDs for a better passthrough experience. The focal length of the lens array, f, approximately sets the thickness of the passthrough camera. Reference is made to FIG. 5A, which illustrates a graph 200 depicting a relationship between a distance from a camera sensor to an eye and a focal length. FIG. 5A and Eq. (1) show that choosing shorter focal lengths reduces zₐₚ, moving the apertures 110 closer to the sensor 112. In practice, physical limitations may prevent the apertures 110 from being arbitrarily close to the sensor 112. For example, camera coverglass may limit aperture placement and the apertures 110 themselves may have some non-negligible thickness. As the distance from the camera to the eye gets larger, a longer focal length lens may be chosen to accommodate these restrictions. This suggests that better camera form factors may be achieved when the headset itself is also thin, enabling shorter z_{eye}.

FIG. 5B illustrates a graph 210 depicting a relationship between a distance from a camera sensor to an eye and a lens array size. The field of view plotted in FIG. 5B may be determined by the headset track length and the lateral size of the lens array. As z_{eye} increases with thicker headsets, a larger lens arrays may be required. Instead, VR is trending towards thinner headsets through use of pancake lenses. These thinner headsets, on the order of 30 mm from eye to front surface, may enable a 90° field of view without any physical overlap between the cameras associated with each eye.

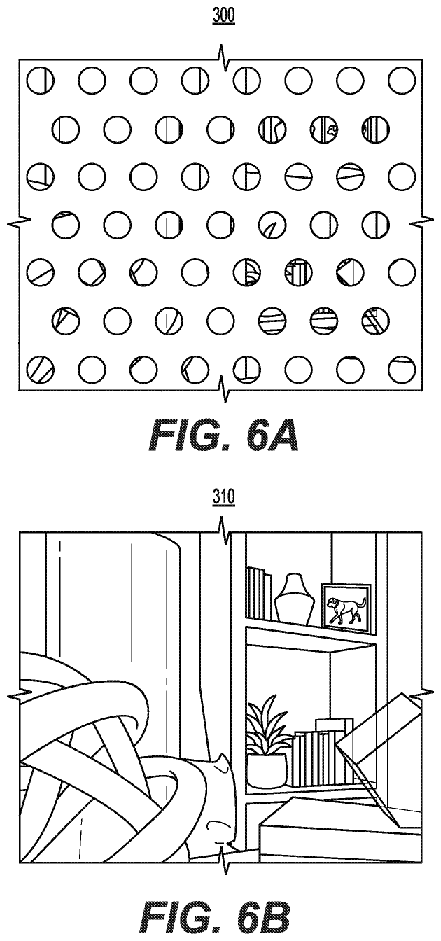

FIG. 6A illustrates a representation of raw sensor data 300 captured through the image capture device 102 of a scene 310 illustrated in FIG. 6B, according to an example. According to examples, post-processing may be implemented on the raw sensor data 300 shown in FIG. 6A as the raw sensor data 300 includes many sub-aperture views rather than a complete image of a scene 310. Theoretically, with an ideal lens array, prior knowledge of the lens 108 locations may be used to simply rearrange the sub-aperture views into the final passthrough image. However, in practice, the exact lens 108 locations may be unknown, and, furthermore, distortion within each lens 108 may create discontinuities or ghosts artifacts in the reconstruction.

According to examples, both unknown lens locations and distortion may be corrected simultaneously by calibrating a dense mapping from sensor pixels to output image pixels using Gray codes displayed on a display. Then, a reconstruction algorithm may include rearranging the pixels based on the calibration and applying a flat-field correction. This algorithm is extremely lightweight making it suitable for low latency passthrough. However, ghost artifacts due to depth dependence of the calibration and visible seams between sub-images due to stray light may exist. The following discussion describes in greater detail on where these artifacts come from and how they may be corrected according to examples of the present disclosure.

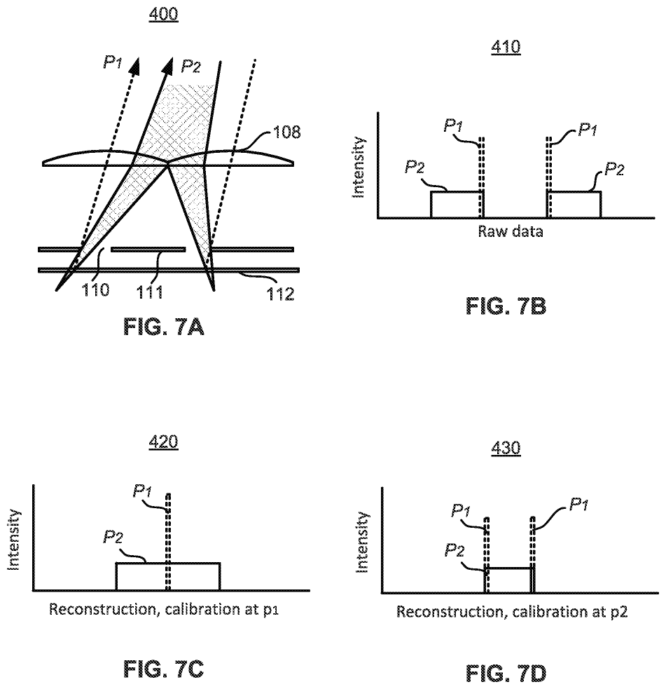

FIG. 7A illustrates a diagram 400 that depicts lenses 108 focused at a point p₁ (dashed line) and a closer point p₂ (solid line) that focuses behind the sensor 112, creating a defocus blur in the raw data, as shown in the graph 410 in FIG. 7B, according to an example. Particularly, the diagram 400 depicts rays corresponding to two points at different depths. p1, at the further depth, is in focus on the sensor 112, and p2, at the closer depth, focuses behind the sensor 112, creating defocus blur in the raw data (FIG. 7B). If the calibration is done at the plane of p1, the points in the raw data corresponding to p1 will line up in the reconstruction; the result is shown in the graph 420 in FIG. 7C, where p1 is in focus and p2 is defocused. Note that the defocus bokah of p2 is spread between the two lenses 108 in FIG. 7A and does not get overlapped in the final reconstruction, resulting in more defocus blur in the final image than in each sub-aperture view individually. In contrast, if the calibration is done at the plane of p2, the points in the raw data corresponding to p2 are aligned, resulting in the reconstructed intensity as shown in the graph 430 in FIG. 7D, with the undesirable consequence of p1 being doubled in the image.

This example implies that the calibration should be done at the focal plane of the image capture device 102. However, due to field curvature of the lenses 108, there may not be a single plane where all of the lenses 108 are simultaneously in focus, resulting in doubling artifacts for objects off the plane of calibration. When calibration is at the background, there may be artifacts in the foreground. These are resolved with a foreground calibration, but the background then may have severe doubling. In this scenario, a reconstruction algorithm may be employed, in which the reconstruction algorithm may be depth-dependent or depth-independent.

Given a depth map, a clean image over the full field of view may be reconstructed by choosing the correct calibration for each pixel. Since many mixed reality applications may require depth maps, one option is to simply leverage the depth maps. If that is not an option, a coarse depth estimation using the overlap between lenses with an adapted block-matching approach may be used. Although these depth maps may typically be very low resolution and contain only a handful of planes, the improvement using the depth estimation is apparent since both the foreground and background are reconstructed without doubling artifacts. Unlike traditional depth-based reprojection, inaccuracies in the depth map disclosed herein may have minimal consequence on the reconstruction since points in the output only move by a small number of pixels as a function of depth.

Even with a flat-field correction, stray light may cause differences in intensity between sub-aperture views resulting in noticeable seams in the reconstruction. According to examples, gradient domain image editing (GDIE) techniques may be applied for seamless stitching. In these examples, spatial gradients of each of the sub-aperture images may be computed, smoothly blended into a single gradient image, and then converted back to the image domain using, for instance, a Fast Fourier Transform (FFT) method, which may be implemented efficiently on the GPU. In some examples, the low frequencies of the gradient domain output may optionally be constrained to match those of the reconstruction without GDIE blending. In some examples, the low frequencies of the gradient domain output may be constrained to match those of the reconstruction without GDIE blending.

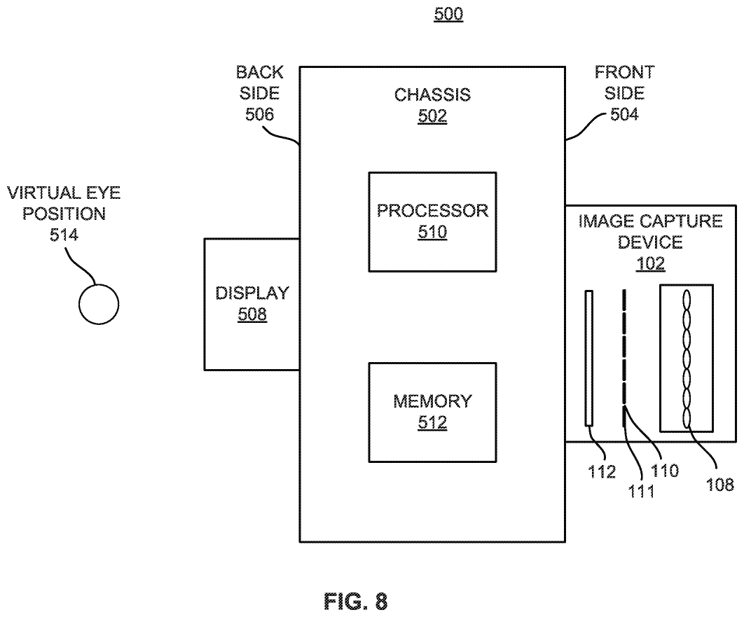

FIG. 8 illustrates a block diagram of a HMD 500 that includes an image capture device 102 that is to enable the display of a scene at a perspective that matches a virtual eye position that is offset from the location of a sensor 112 in the image capture device 102, according to an example. As shown, the HMD 500 may include a chassis 502 having a front side 504 and a back side 506. The image capture device 102 may be mounted or otherwise provided on the front side 504 of the chassis 502. The image capture device 102 may also include a display 508 mounted or otherwise provided on the back side 506 of the chassis 502.

The chassis 502 may include features that enable a user to wear the HMD 500 such that the display 508 may be positioned within a comfortable field of view of a user of the HMD 500. The features may include head straps, face supports, etc.

The chassis 502 may also house or otherwise include a processor 510 that may control operations of various components of the HMD 500. The processor 510 may be a semiconductor-based microprocessor, a central processing unit (CPU), an application-specific integrated circuit (ASIC), a field-programmable gate array (FPGA), and/or other hardware device. The processor 510 may be programmed with software and/or firmware that the processor 510 may execute to control operations of the components of the HMD 500.

According to examples, the chassis 502 may house or otherwise include a memory 512, which may also be termed a computer-readable medium 512. The memory 512 may be an electronic, magnetic, optical, or other physical storage device that contains or stores executable instructions. The memory 512 may be, for example, Random Access memory (RAM), an Electrically Erasable Programmable Read-Only Memory (EEPROM), a storage device, or an optical disc. For instance, the memory 512 may have stored thereon instructions that cause the processor 510 to access raw sensor data having a plurality of sub-aperture views of a scene, in which the plurality of sub-aperture views include views of light that would have reached a virtual eye position 514 that is spaced from the sensor 112 that captured the raw sensor data. The instructions may also cause the processor 510 to apply a reconstruction algorithm on the plurality of sub-aperture views and instructions that may cause the processor 510 to apply gradient domain image stitching to the calibrated plurality of sub-apertures to generate a stitched image, in which the stitched image is to accurately reproduce the image at a perspective that matches the virtual eye position 514.

The instructions may further cause the processor 510 to cause the stitched image to be displayed on the display 508 of the HMD 500. As a result, a user of the HMD 500 may be provided with a passthrough view of a scene in front of the chassis 502 that is at a perspective that is intended to match the virtual eye position 514. The passthrough view of the scene may thus be a more accurate representation of the scene.

Although not shown, the chassis 502 may house or otherwise include additional components for processing images captured by the image capture device 102 and for displaying the processed images on the display 508. The additional components may include display electronics, display optics, and an input/output interface (which may interface with one or more control elements, such as power buttons, volume buttons, a control button, a microphone, and other elements through which a user may perform input actions on the HMD 500). The additional components may also include one or more position sensors that may generate one or more measurement signals in response to motion of the HMD 500 (which may include any number of accelerometers, gyroscopes, magnetometers, and/or other motion-detecting or error-correcting sensors, or any combination thereof), an inertial measurement unit (IMU) (which may be an electronic device that generates fast calibration data based on measurement signals received from the one or more position sensors 126), and/or an eye-tracking unit that may include one or more eye-tracking systems. As used herein, “eye-tracking” may refer to determining an eye's position or relative position, including orientation, location, and/or gaze of a user's eye. In some examples, an eye-tracking system may include an imaging system that captures one or more images of an eye and may optionally include a light emitter, which may generate light that is directed to an eye such that light reflected by the eye may be captured by the imaging system. In other examples, the eye-tracking unit may capture reflected radio waves emitted by a miniature radar unit. The data associated with the eye may be used to determine or predict eye position, orientation, movement, location, and/or gaze.

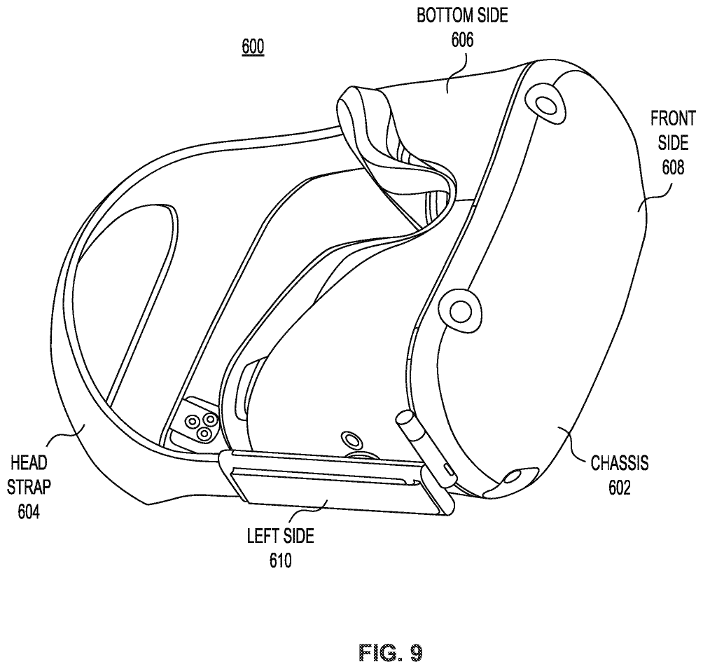

FIG. 9 illustrates a perspective view of a HMD 600, according to an example. The HMD 600 may include each of the features of the HMD 500 discussed herein. In some examples, the HMD 600 may be a part of a virtual reality (VR) system, an augmented reality (AR) system, a mixed reality (MR) system, another system that uses displays or wearables, or any combination thereof. In some examples, the HMD 600 may include a chassis 602 and a head strap 604. FIG. 9 shows a bottom side 606, a front side 608, and a left side 610 of the chassis 602 in the perspective view. In some examples, the head strap 604 may have an adjustable or extendible length. In particular, in some examples, there may be a sufficient space between the chassis 602 and the head strap 604 of the HMD 600 for allowing a user to mount the HMD 600 onto the user's head. In some examples, the HMD 600 may include additional, fewer, and/or different components. For instance, the HMD 600 may include an image capture device 102 (not shown) in FIG. 9 through which images may be captured and passed through the chassis 602 as discussed herein.

In some examples, the HMD 600 may present, to a user, media or other digital content including virtual and/or augmented views of a physical, real-world environment with computer-generated elements. Examples of the media or digital content presented by the HMD 600 may include images (e.g., two-dimensional (2D) or three-dimensional (3D) images), videos (e.g., 2D or 3D videos), audio, or any combination thereof. In some examples, the images and videos may be presented to each eye of a user by one or more display assemblies (not shown in FIG. 9) enclosed in the chassis 602 of the HMD 600.

In some examples, the HMD 600 may include various sensors (not shown), such as depth sensors, motion sensors, position sensors, and/or eye tracking sensors. Some of these sensors may use any number of structured or unstructured light patterns for sensing purposes. In some examples, the HMD 600 may include an input/output interface for communicating with a console, such as the certain computing apparatus. In some examples, the HMD 600 may include a virtual reality engine (not shown), that may execute applications within the HMD 600 and receive depth information, position information, acceleration information, velocity information, predicted future positions, or any combination thereof of the HMD 600 from the various sensors.

It should be appreciated that in some examples, a projector mounted in a display system may be placed near and/or closer to a user's eye (i.e., “eye-side”). In some examples, and as discussed herein, a projector for a display system shaped liked eyeglasses may be mounted or positioned in a temple arm (i.e., a top far corner of a lens side) of the eyeglasses. It should be appreciated that, in some instances, utilizing a back-mounted projector placement may help to reduce the size or bulkiness of any required housing required for a display system, which may also result in a significant improvement in user experience for a user.

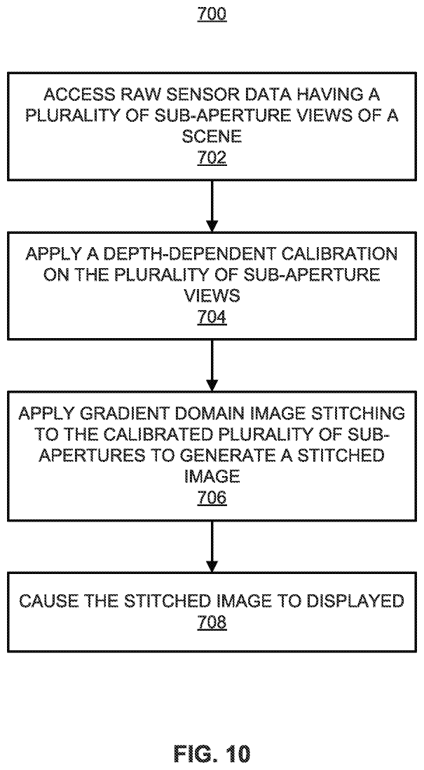

Various manners in which the processor 510 of the HMD 500 may operate are discussed in greater detail with respect to the method 700 depicted in FIG. 10. FIG. 10 illustrates a flow diagram of a method 700 for reproducing an image at a perspective that matches a virtual eye position 514, according to an example. It should be understood that the method 700 depicted in FIG. 10 may include additional operations and that some of the operations described therein may be removed and/or modified without departing from the scope of the method 700. The description of the method 700 is made with reference to the features depicted in FIGS. 1-8 for purposes of illustration.

At block 702, the processor 510 may access raw sensor data having a plurality of sub-aperture views of a scene, in which the plurality of sub-aperture views include views of light that would have reached a virtual eye position 514 that is spaced from a sensor 112 that captured the raw sensor data.

At block 704, the processor 510 may apply a reconstruction algorithm on the plurality of sub-aperture views.

At block 706, the processor 510 may apply gradient domain image stitching to the calibrated plurality of sub-apertures to generate a stitched image, in which the stitched image is to accurately reproduce the image at a perspective that matches the virtual eye position 514.

At block 708, the processor 510 may cause the stitched image to be displayed on the display 508 of the HMD 500.

The application of the method 700 may enable an optimization algorithm to be applied to the collected sensor data to reproduce an image of a scene that is captured in front of the HMD 500 at a perspective that is intended to match a virtual eye position 514 that is offset from the location of the sensor 112. As a result, the perspective-correct view of a scene may be passed through the chassis 502 to a user of the HMD 500. This may enable the user to better view and interact with objects in front of the user while the user is using the HMD 500.

Some or all of the operations set forth in the method 700 may be included as a utility, program, or subprogram, in any desired computer accessible medium. In addition, the method 700 may be embodied by a computer program, which may exist in a variety of forms both active and inactive. For example, they may exist as machine-readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

In the foregoing description, various inventive examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example’ is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. An image capture device, comprising:
a lens array including a plurality of lenses supported by a lens support structure, wherein the plurality of lenses are arranged to capture light rays from multiple view-points;
a sensor to capture light and convert the captured light into data that is used to form an image; and
a plurality of apertures positioned between the lenses and the sensor, wherein the plurality of apertures are positioned with respect to the lenses and the sensor to allow rays of light that would have reached a certain reference location spaced from the sensor to pass through the plurality of apertures.

2. The image capture device of claim 1, wherein sections between the plurality of apertures are positioned to physically block rays of light that would not have reached the certain reference location through the plurality of lenses.

3. The image capture device of claim 1, wherein the plurality of lenses spatially multiplex a spatio-angular light field impinging on the sensor onto different regions of the sensor.

4. The image capture device of claim 1, wherein the plurality of lenses selectively pick off incoming light rays that converge to the certain reference location.

5. The image capture device of claim 1, wherein each of the plurality of lenses has a respective pupil that only accepts rays within a predefined angular range for a corresponding position on the sensor.

6. The image capture device of claim 5, wherein prescriptions, sizes, and locations of the pupils are jointly optimized for a geometry of the sensor and the certain reference location.

7. The image capture device of claim 1, wherein the certain reference location comprises a target center of perspective of a user of the image capture device.

8. The image capture device of claim 1, wherein the image capture device is to be mounted on a front side of a head-mountable display to capture images of an environment in front of the head-mountable display and wherein the certain reference location comprises a virtual eye position behind the head-mountable display.

9. A head-mounted display, comprising:
a chassis having a front side and a back side; and
an image capture device mounted to the front side of the chassis, the image capture device including:
a lens array including a plurality of lenses supported by a lens support structure, wherein the plurality of lenses are arranged to capture light rays from multiple view-points;
a sensor to capture light and convert the captured light into data that is used to form an image; and
a plurality of apertures positioned between the lenses and the sensor, wherein the plurality of apertures are positioned with respect to the lenses and the sensor to allow rays of light that would have reached a virtual eye position spaced from the sensor to pass through the plurality of apertures, wherein the virtual eye position is positioned behind the back side of the chassis.

10. The head-mounted display of claim 9, further comprising:
a processor; and
a memory on which is stored machine-readable instructions that when executed by the processor, cause the processor to:
access raw sensor data having a plurality of sub-aperture views of a scene, wherein the plurality of sub-aperture views comprise views of light that would have reached the virtual eye position that is spaced from a sensor that captured the raw sensor data;
apply a reconstruction algorithm on the plurality of sub-aperture views; and
apply gradient domain image stitching to the plurality of sub-apertures following the application of the reconstruction algorithm to generate a stitched image, wherein the stitched image is to accurately reproduce the image at a perspective that matches the virtual eye position.

11. The head-mounted display of claim 10, wherein the raw sensor data was captured by the image capture device, the head-mounted display having a display positioned on the back side of the chassis, the instructions further causing the processor to:
cause the stitched image to be displayed on the display of the head-mounted display.

12. The head-mounted display of claim 9, wherein the lens support structure is to physically block rays of light that would not have reached the virtual eye position through the plurality of lenses.

13. The head-mounted display of claim 9, wherein the plurality of lenses spatially multiplex a spatio-angular light field impinging on the sensor onto different regions of the sensor.

14. The head-mounted display of claim 9, wherein the plurality of lenses selectively pick off incoming light rays that converge to the virtual eye position.

15. The head-mounted display of claim 9, wherein each of the plurality of lenses has a respective pupil that only accepts rays within a predefined angular range for a corresponding position on the sensor.

16. The head-mounted display of claim 15, wherein prescriptions, sizes, and locations of the pupils are jointly optimized for a geometry of the sensor and the virtual eye position.

17. The head-mounted display of claim 9, wherein the virtual eye position comprises a target center of perspective of a user of the head-mounted display.

18. A method comprising:
accessing, by a processor, raw sensor data having a plurality of sub-aperture views of a scene, wherein the plurality of sub-aperture views comprise views of light that would have reached a virtual eye position that is spaced from a sensor that captured the raw sensor data;
applying, by the processor, a reconstruction algorithm on the plurality of sub-aperture views; and
applying, by the processor, gradient domain image stitching to the plurality of sub-apertures following application of the reconstruction algorithm to generate a stitched image, wherein the stitched image is to accurately reproduce the image at a perspective that matches the virtual eye position.

19. The method of claim 18, wherein the raw sensor data was captured by an image capture device positioned on a front side of a head-mounted display, the head-mounted display having a display positioned on a back side of the head-mounted display, the method further comprising:
causing the stitched image to be displayed on the display of the head-mounted display.

20. The method of claim 19, wherein the image capture device comprises:
a lens array including a plurality of lenses supported by a lens support structure, wherein the plurality of lenses are arranged to capture light rays from multiple view-points;
a sensor to capture light and convert the captured light into data that is used to form an image; and
a plurality of apertures positioned between the lenses and the sensor, wherein the plurality of apertures are positioned with respect to the lenses and the sensor to allow rays of light that would have reached a virtual eye position spaced from the sensor to pass through the plurality of apertures, wherein the virtual eye position is positioned behind the back side of the image capture device.
